(19) United States
(12) Patent Application Publication
(10) Pub. No.: US 2024/0153228 A1
(43) Pub. Date: May 9, 2024

(54) SMART SCENE BASED IMAGE CROPPING

(71) Applicant: Black Sesame Technologies Inc., San Jose, CA (US)

(72) Inventors: HungTing Liu, Singapore (SG); Bo Li, Singapore (SG); Shuen Lyu, Singapore (SG)

(21) Appl. No.: 17/980,322

(22) Filed: Nov. 3, 2022

(51) Int. Cl. G06V 10/25; G06T 7/13; G06V 10/44; G06V 10/74; G06V 10/762; G06V 10/771

(52) U.S. Cl. CPC G06V 10/25; G06T 7/13; G06V 10/44; G06V 10/761; G06V 10/762; G06V 10/771; G06T 2207/20132; G06T 2207/30201; G06V 2201/07

(57) ABSTRACT

Disclosed is a system for automatic cropping of an image of interest from a video sample using smart systems. The image of interest is an image representative of the video sample, which includes desirable characteristics as required by the user, such as a person or object of focus, a specific aspect-ratio, preferred landmarks, information/time-stamps etc. The system for automatic cropping analyzes the video sample and its content to detect at least one image feature. The image feature is then classified based on importance and a potential test cropping area is determined based on the cumulative importance of features detected within each frame. The smart cropping systems and methods disclosed ensure that the most relevant aspects of a video sample are included within the image of interest.

### FIELD OF THE INVENTION

The present invention generally relates to the field of video editing and reframing techniques. More particularly, the present invention relates to smart snapshot cropping solutions for video thumbnails, filters, and tag generation.

### BACKGROUND OF THE INVENTION

With the recent increase in smart-phone users around the world, more people are connected via the internet resulting in ever increasing online content generation and consumption. The most common and popular type of content is visual content, i.e. photos and videos. As the number of smart-phone based social networking applications available to the public is increasing, people are looking for an easy-to-use application for visual content editing, especially the editing of videos. Video related content creation demands a considerable amount of processing and editing when compared to image based content creation.

During video content creation, it is typical for a user to preserve important information within a video but to remove junk data. This step is relevant, wherein the user generates thumbnails or synopsis clips for her video content. A traditional approach for reframing a video to a certain aspect-ratio involves static cropping. Static cropping includes specifying a viewpoint and simply cropping the area outside the viewpoint. However, this technique is prone to errors as it is not possible to have various video samples having the same composition or camera work. Moreover, the feature of interest can either get split while being cropped or get omitted from the cropping because the feature is off-center from the viewpoint.

Most of the application based solutions available use a basic two-step approach to solve this problem: identifying the feature and determining the cropping area. The feature identification involves salient parts of an image or a screenshot derived from a video sample and prediction of their presence in the image. Machine learning based approaches are then applied to determine a cropping region, which gets cropped from the image using a corresponding solution or tool.

There are several prior art references relevant to the present invention. In U.S. Pat. No. 9,336,567, the edge information of the image is extracted and accumulated across multiple frames of a video sample. The method further includes cropping the image at an overlay region (of edge information) of a desired size that is set at the center of the image.

In an alternate approach to feature identification, U.S. Pat. No. 10,318,794 and US Patent Application No. 20130101210 both disclose an automatic cropping solution based on identifying noticeable difference within regions of an image to determine an area to be cropped. The '794 Patent uses facial recognition and emotion detection to locate a predicted sector to be cropped, while the 20130101210 Application uses a saliency map to crop an object of interest from the image. For example, darker shades represent pixels with greater saliency values and lighter shades represent pixels with smaller saliency values. The difference in pixels according to color patches of multiple scales is detected to effectively identify an object.

EP Patent No. 1120742 uses multiple models instead of one to identify and locate features in a digital image. Using multiple models to detect faces or backgrounds makes the system more reliable as important subjects are accessible to system to generate a cropping area. The generated cropping area in the shape of a box is initialized at the centroid of the region with high confidence and further optimized around the neighboring region.

It is noted that the cited approaches above used for video and image cropping are narrowly focused on feature detection and localization in order to decrease unsatisfactory image cropping events.

Therefore, to overcome the shortcomings of the prior art, there is a need to provide a multilevel feature extraction approach based on scene recognition. The scene recognition combines both low level and high level features to increase system accuracy with respect to object awareness.

It is apparent now that numerous methods and systems are developed in the prior art that are adequate for various, albeit narrow, purposes. Furthermore, even though these inventions may be suitable for their specific purposes, they are not suitable for the purposes of the present invention, as heretofore described. Thus, there is a need to provide an automated cropping system that uses model based approaches without customization for significant information.

### SUMMARY OF THE INVENTION

In accordance with the present invention, the disadvantages and limitations of the prior art are substantially avoided by providing a smart cropping system for generating an image of interest from a video. The smart cropping system includes a scene segmentation module for segmenting a video. The video includes a number of frames. Further, the scene segmentation module includes a cluster generator for generating multiple clusters of frames from the frames of the video. The cluster generator generates the cluster of frames based on a determined similarity between the frames. The cluster of frames is generated by using an algorithm or software module, such as a K means-algorithm, UV histograms, and/or color-space characteristics. Further, the scene segmentation module includes a scene generator for generating a number of scenes from the cluster of frames and further merging the scenes to form a scene segment.

The smart cropping system includes a feature processing module for analyzing the scene segment and at least one frame associated with the scene segment to extract a number of features. Moreover, a number of features are stacked together on the at least one frame to form a stacked feature frame. The feature processing module includes a feature extractor for extracting a number of features. The features may be selected from a group including a face, object, background, scene, edge, and/or animal. The feature processing module includes a feature concatenation unit for stacking the number of features to form the stacked feature frame.

The smart cropping system includes a scoring module for assigning a score to the stacked feature frame. The scoring module assigns the score to the stacked feature frame based on the number of features, a number of occurrences of the features, edges detected from the features, lengths of the number of scenes, or a confidence value of the features. The confidence value is based on AI-based training models or any machine learning based training models. The confidence value is based on the features and on the similarity value of those features. The similarity value is checked from sample images gathered from websites, online databases, or social networks. The scoring module generates a bounding box on the basis of the score assigned to the stacked feature frame. The bounding box is used to generate feature maps, which are used later by a region localizer to locate test areas.

The smart cropping system includes a cropping module for cropping and thereby generating an image of interest. The cropping module includes a region localizer for scanning the stacked feature frame and detecting multiple test areas within the stacked feature frame. In one exemplary embodiment, the region localizer scans the feature maps to detect the multiple test areas. Further, the bounding box is enclosed within the number of test areas.

The cropping module includes a deformer for resizing one test area from the number of test areas. The one test area is generated on the basis of the score assigned by the scoring module. Further, the cropping module includes a cropper for cropping a portion of the test area to generate the image of interest.

The primary objective of the present invention is to provide a smart cropping system which uses a deep learning model with a traditional feature detection approach that can be applied to scenes with or without dominant objects, such as humans.

Another objective of the present invention is to provide a video-based cropping technique which uses occurrence of objects at neighboring frames.

Yet another objective of the present invention is to provide an object attention smart cropping method that alleviates erroneous cropping as a result of false recognition in a single frame. In order to reduce false recognition, a feature processing module includes a feature extractor. The feature extractor uses each of the one or more features, whether an object, person, background composition, or simply edges of those features, to compare against large pools of reference images derived from online sources, to ensure high fidelity feature detection.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g. boxes, groups of boxes, or other shapes) in the figures each represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1(A) illustrates a smart cropping system for generating an image of interest from a video in accordance with the present invention;

FIG. 1(B) illustrates a feature processing module in accordance with the present invention;

FIG. 2 illustrates an automated cropping system for generating the image of interest from the video in accordance with the present invention;

FIG. 3 illustrates a flowchart representing a smart cropping system using a multilevel feature extraction approach based on scene recognition combining low and high-level features followed by object based post-processing in accordance with the present invention;

FIG. 4 illustrates a scene segmentation module in accordance with the present invention;

FIG. 5 illustrates a feature processing module in accordance with the present invention;

FIG. 6 illustrates a scoring module in accordance with the present invention;

FIG. 7(A) illustrates a region localizer of a cropping module in accordance with the present invention;

FIG. 7(B) illustrates a deformer of the cropping module in accordance with the present invention;

FIG. 8 illustrates a method for smart cropping for generating the image of interest in accordance with present invention; and

FIG. 9 illustrates an alternative embodiment of an automated cropping method for generating the image of interest in accordance with the present invention.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention.

Also, the terminology and phraseology used is for the sole purpose of describing exemplary embodiments and should not be considered limiting. Thus, the present invention is to be accorded the broadest scope encompassing numerous alternatives, modifications, and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise,” “include,” “have,” “contain,” and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

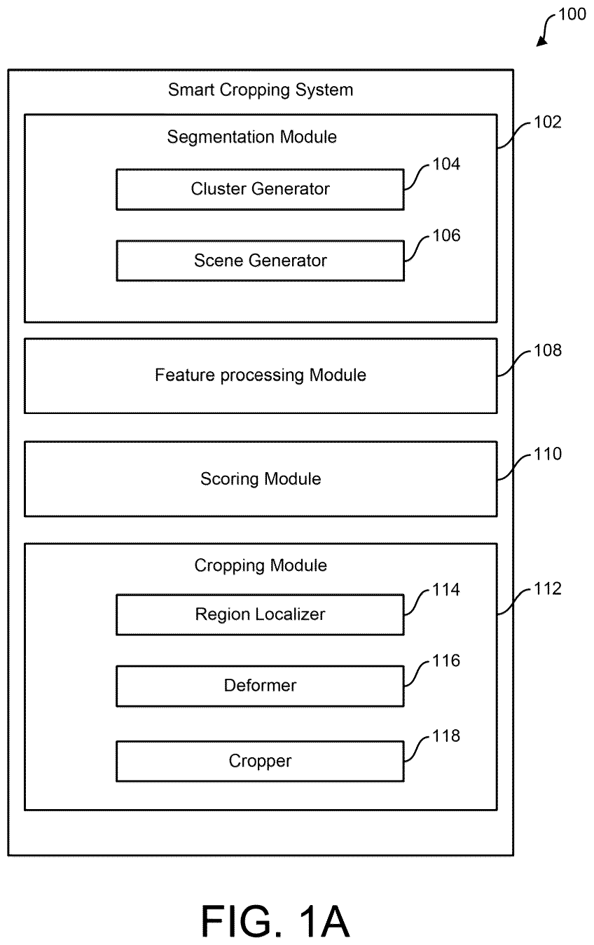

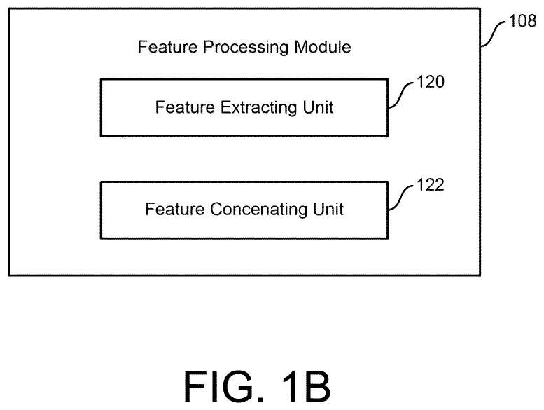

FIG. 1(A) illustrates a smart cropping system (100) for generating an image of interest from a video according to a preferred embodiment of the present invention. The smart cropping system (100) includes a scene segmentation module (102) for segmenting a video. The video includes a number of frames. Further, the scene segmentation module (102) includes a cluster generator (104) for generating multiple clusters of frames from the number of frames of the video.

The cluster generator (104) generates the cluster of frames based on similarities between the frames. The cluster of frames is generated using an algorithm or software module, such as a K means-algorithm, UV histograms, and/or color-space characteristics.

Further, the scene segmentation module (102) includes a scene generator (106) for generating a number of scenes from the cluster of frames and further merging the scenes to form a scene segment.

According to a preferred embodiment of the present invention, an automated system for generating an image of interest from a video is provided. The automated system uses a cropping system, in which the video is first partitioned based on a cluster of frames, from individual frames that make up a length L of the video. These clusters of frames are further merged based on content characteristics and similarity between consecutive frames to make a scene segment. Hence, the video is ultimately divided into several scene segments.

The scene segment is used to extract one or more features on a frame-by-frame basis. The features extracted are objects or salient features contained within the scene segment, such as human faces, animals, plants, background, etc. One or more features are detected within at least one frame of the scene segment. The one or more features are concatenated or layered on top of each other within a frame of the scene segment.

The smart cropping system (100) includes a feature processing module (108) for analyzing the scene segment and at least one frame associated with the scene segment to extract a number of features. Further, the number of features are stacked together on the at least one frame to form a stacked feature frame. The feature processing module (108) includes a feature extractor for extracting the number of features. The features may be selected from a group including a face, an object, a background, a scene, an edge, or an animal. The feature processing module (108) includes a feature concatenation unit for stacking the number of features to form a stacked feature frame.

The smart cropping system (100) includes a scoring module (110) for assigning a score to the stacked feature frame. The scoring module (110) assigns the score to the stacked feature frame based on each of the features, the frequency of the features, edges detected from the features, lengths of the scenes, or a confidence value of the features. The confidence value is based on an AI-based training model or any machine learning based training model.

The confidence value is based on the features and similarity value of those features. The similarity value is checked from sample images gathered from websites, online databases, or social networks. Further, the scoring module (108) generates a bounding box on the basis of the score assigned to the stacked feature frame. Further, the bounding box is used to generate feature maps, which are later used by a region localizer to locate test areas.

The smart cropping system (100) includes a cropping module (112) for cropping and thereby generating the image of interest. Further, the cropping module (112) includes a region localizer (114) for scanning the stacked feature frame and detecting multiple test areas within the stacked feature frame. In one exemplary embodiment of the present invention, the region localizer (114) scans the feature maps to detect multiple test areas. Further, a bounding box is enclosed within the test areas.

The cropping module (112) includes a deformer (116) for resizing one test area from the test areas. The one test area is generated on the basis of the score assigned by the scoring module (110). Further, the cropping module (112) includes a cropper (116) for cropping a portion of the test area to generate the image of interest.

FIG. 1(B) illustrates a feature processing module (108) according to a preferred embodiment. The feature processing module (108) analyzes the scene segment and at least one frame associated with the scene segment to extract a number of features. Further, the feature processing module (108) includes a feature extractor (120) for extracting a number of features from the scene segment and at least one frame associated with the scene segment. Further, the feature processing module (108) includes a feature concatenation unit (122) for stacking the number of features to form a stacked feature frame.

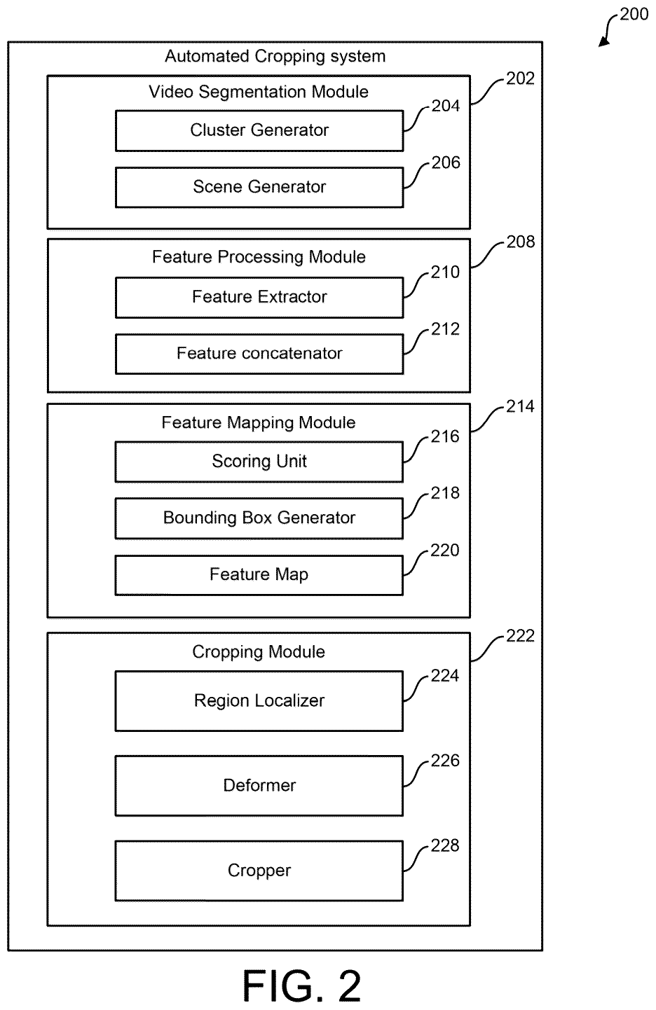

FIG. 2 illustrates an automated cropping system (200) for generating an image of interest from a video sample according to a preferred embodiment. The automated cropping system (200) includes a video segmentation module (202) for segmenting the video sample. The video sample includes a number of frames. Further, the video segmentation module (202) includes a cluster generator (204) for generating multiple clusters of frames from the number of frames of the video sample.

The cluster generator (204) generates the cluster of frames based on a determined similarity between the frames. The cluster of frames is generated using an algorithm or a software module, such as a K means-algorithm, UV histograms, or color-space characteristics. Further, the video segmentation module (202) includes a scene generator (206) for generating a number of scenes from the cluster of frames and further merging the number of scenes to form a scene segment.

The automated cropping system (200) including a feature processing module (208) for analyzing the scene segment and at least one frame associated with the scene segment to extract a number of features. A number of features are stacked together on at least one frame to form a stacked feature frame.

The feature processing module (208) includes a feature extractor (210) for extracting a number of features from the scene segment and at least one frame associated with the scene segment. The feature processing module (208) includes a feature concatenation unit (212) for stacking the number of features to form the stacked feature frame.

The automated cropping system (200) includes a feature mapping module (214) for assigning a score and thereafter generating a number of feature maps, which are used later by a region localizer to locate test areas. The feature mapping module (214) includes a scoring unit (216) for assigning a score to the stacked feature frame. The scoring unit (216) assigns the score to the stacked feature frame based on each of the features, the frequency of the features, edges detected of the number of features, lengths of the scenes, or a confidence value of the features. The confidence value is based on AI-based training models or any machine learning based training models. The confidence value is based on the features and similarity value of those scenes. The similarity value is checked from the sample images gathered from websites, online databases, or social networks.

The feature mapping module (214) includes a bounding box generator (218) for generating bounding boxes on the basis of the score assigned to the stacked feature frame. Smaller bounding boxes are filled with lower confidence values. In addition, the smaller bounding boxes are less bright or have a lower brightness value. Larger bounding boxes are filled with high confidence values. The larger bounding boxes have a high brightness value based on the score assigned to the stacked feature frame generated from the feature processing module (208).

The feature mapping module (214) includes a feature map unit (220) for generating a number of feature maps based on the bounding boxes. The maps are later used by a region localizer to locate test areas.

The automated cropping system (200) includes a cropping module (222) for cropping and thereby generating an image of interest. The cropping module (222) includes a region localizer (224) for scanning the stacked feature frame and detecting a multiple test areas within the stacked feature frame. In one exemplary embodiment, the region localizer (224) scans the feature maps to detect the multiple test areas. Further, the bounding boxes are enclosed within the number of test areas.

The cropping module (222) includes a deformer (226) for resizing one test area from the test areas. The one test area is generated on the basis of the score assigned by the feature mapping module (214). Further, the cropping module (222) includes a cropper (228) for cropping a portion of the test area to generate the image of interest.

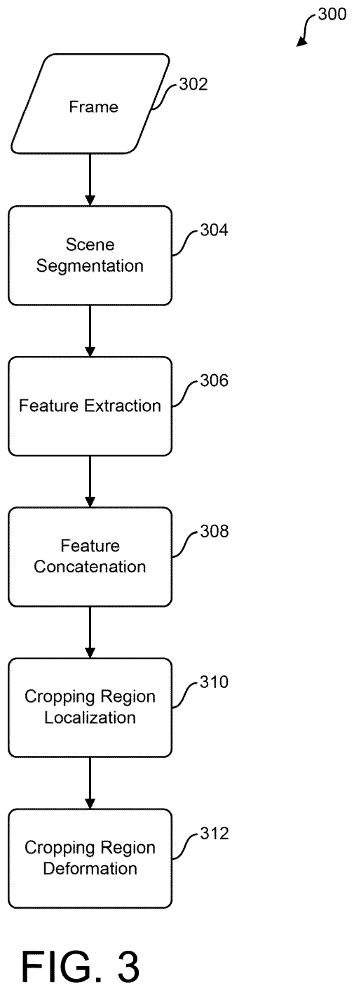

FIG. 3 illustrates a flowchart (300) representing a smart cropping system using a multilevel feature extraction approach. The approach is based on scene recognition that combines low and high level features followed by object based post-processing. A video, includes frames (302), is further used for generating an image of interest. Further, the frames (302) are segmented by using a segmentation module.

The frames (302) are segmented by scene segmentation (304). The scene segmentation (304) includes a step of converting the frames into a cluster of frames by a cluster generator. Further, the cluster of frames is segmented into scenes and thereafter merged to form scene segments.

A feature extraction step (306) is performed on the number of scene segments. The feature extraction (306) includes a step of extracting a number of features by analyzing the scene segments and at least one frame associated with the scene segments.

A feature concatenation step (308) is performed on the extracted features from the scene segments and at least one frame associated with the scene segments. The feature concatenation (308) includes a step of stacking a number of features to form a stacked feature frame.

A cropping region selection step (310) is performed on the stacked feature frame. The cropping region selection (310) includes a step of scanning the stacked feature frame to detect a number of test areas. In an exemplary embodiment, the region selection (310) is done by a region localizer for scanning the stacked feature frame and detecting multiple test areas within the stacked feature frame. In one exemplary embodiment, the region localizer scans the feature maps to detect the multiple test areas. Further, the bounding boxes are enclosed within the number of test areas.

Further, a cropping region deformation operation (312) step is performed on the number of test areas. The cropping region deformation (312) includes a step of deforming the number of test areas. In one exemplary embodiment of the present invention, the cropping region deformation (312) includes a step of resizing one test area from the number of test areas. The one test area is generated on the basis of the score assigned by the scoring module (110), and a portion of the test area is cropped to generate the image of interest.

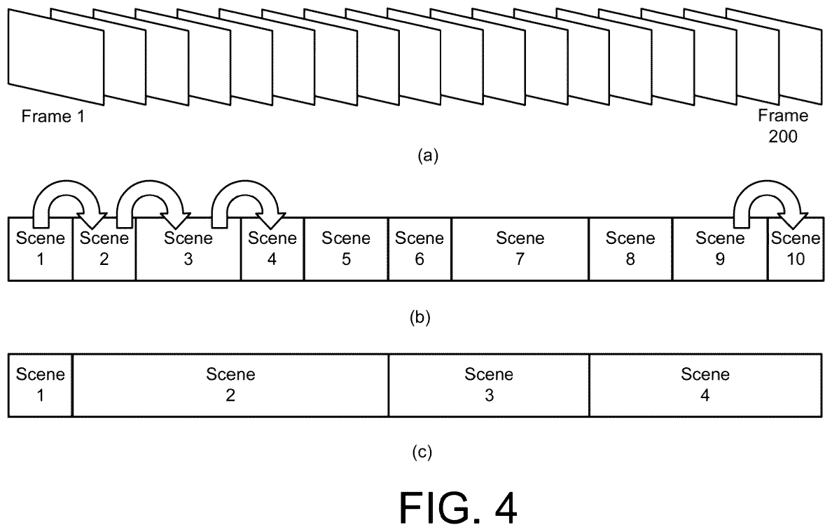

FIG. 4(A)-4(C) illustrates a scene segmentation module for segmenting a video or a video sample. Referring to FIG. 4(A), the scene segmentation module analyzes a video or a video sample. The video includes a number of frames, and the scene segmentation module divides the video into those frames. The scene segmentation module utilizes a top-down approach starting with an understanding of the video or the video samples. The histograms of U and V channel in the YUV color space are concatenated as a one-dimensional feature for each frame. In one exemplary embodiment of the present invention, the scene segmentation module uses a K-means algorithm to divide the video into clips based on the one-dimensional feature as described in an article entitled “Unsupervised video summarization framework using keyframe extraction and video skimming” by Shruti Jadon et. al. The value of K is set as 5% of the length of the video or the video sample. In one exemplary embodiment, K equals to 10 and 15 for videos with 200 and 300 frames. K represents a number of clusters.

A cluster generator of the scene segmentation module generates a number of clusters from the number of frames. A predefined number of clusters K results in over segmentation on some videos with limited scenes. Consequently, the neighboring scenes are further merged based on the similarity of the clusters. The similarity is based on the cosine distance between the UV histogram of neighboring semantic sections, as shown below:

$$CosineDistance ( {hist}_{1} , {hist}_{2} ) = 1 - \frac{{hist}_{1} \cdot {hist}_{2}}{\sqrt{{hist}_{1} \cdot {hist}_{1}} \sqrt{{hist}_{2} \cdot {hist}_{2}}} \qquad ( 1 )$$

The following feature scoring and cropping are measured within each individual scene cluster or cluster of frames. An example with 200 frames is illustrated in FIG. 4(a).

A scene generator of the scene segmentation module generates a number of scenes from the cluster of frames. In an exemplary embodiment, as shown in FIG. 4(B), the scene generator generates a number of scenes from the cluster of frames. The video or cluster of frames is preliminarily divided into 10 scenes of various lengths using a K-means algorithm. The scenes (Scene1 . . . Scene10) are generated by the scene generator using K-means algorithm.

Further, the scene generator merges the scenes to form a scene segment. As shown in FIG. 4(C), the neighboring scenes (Scene1 . . . Scene10) are further merged according to the similarity of the one-dimensional features of the central UV histogram from each scene. The scenes (Scene1 . . . Scene10) are grouped into four sections where each merged scene includes distinctive and compact content. For example, the scenes (Scene1 . . . Scene10) are merged to form four scene segments (Scene segment 1, Scene segment 2, Scene segment 3, and Scene segment 4).

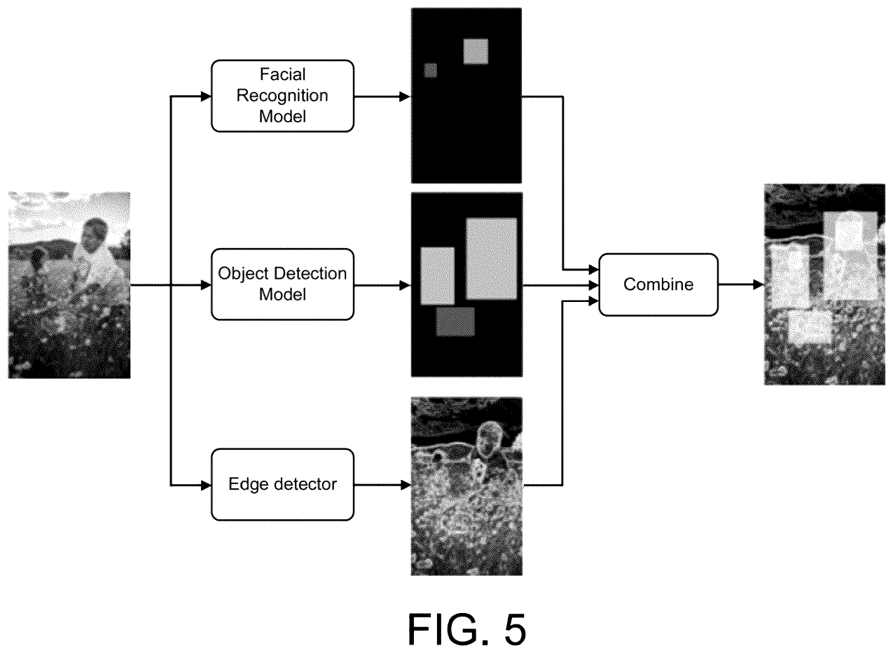

FIG. 5 illustrates a feature processing module. The feature processing module analyzes the scene segments and at least one frame associated with one scene segment to extract one or more features. The feature processing modules includes a feature extractor for extracting a number of features from the scene segments and at least one frame associated with one scene segment.

In one exemplary embodiment, the feature extractor utilizes a face detection model trained to analyze enormous face samples and further apply to the image or the scene segment to locate the faces in the images or the scene segment. Further, the feature extractor utilizes an object detection model trained by using a reasonable number of samples.

The samples include common objects from at least 80 categories. The object detection model identifies samples or objects within the image or within the scene segments. The detected face and objects are projected to a new feature map with the same size. The detections are converted into rectangular patches filled with the confidence value.

As illustrated in FIG. 5, there are two detected faces with different confidence values. The smaller bounding boxes are filled with a lower confidence value and the brighter box on the right is filled with a higher confidence value. The same conversion is applied to the object detection result. Three detected objects are filled with its corresponding confidence value.

Further, the feature extractor is used for detecting a number of edges or edges features of the images or the scene segments. In one exemplary embodiment, an edge detector is applied to extract the edge information from the image. An example of the edge features can be seen in the image at the bottom of FIG. 5.

The feature processing module includes a feature concatenation unit for stacking the number of features on the images or scene segments to form a stacked feature frame. In one alternative embodiment of the present invention, the outputs of the face detection model, the object detection model and edge detector are combined together and laid down on the scene segment or the image.

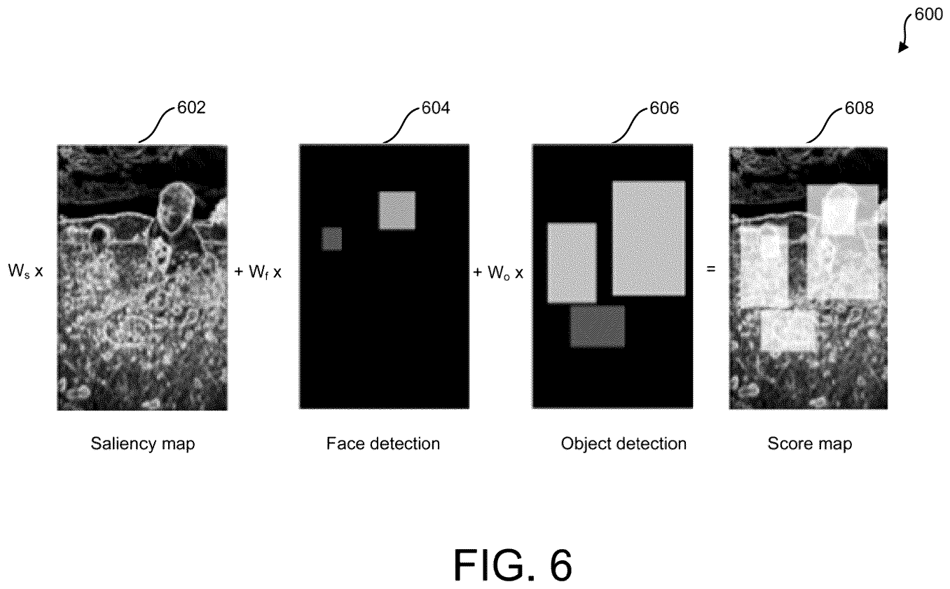

FIG. 6 illustrates a scoring module with the feature processing module. Firstly, a saliency map (602) with respect to an image or a scene segment is detected. The saliency map highlights a region within the image or the scene segment. The saliency map (602) on the image or the scene segment in which the brightness of a pixel represents how salient the pixel is. The goal of the saliency map (602) is to reflect the importance of pixels to the human visual system.

Secondly, face detection (604) represents detection of a face within the image or the scene segment. The face detection model (604) is trained using enormous face samples and further applied to the image or the scene segment to locate the faces in the images or the scene segment. The face detection (604) generates a face map detailing the face of the human.

Thirdly, object detection (606) represents detection of objects within the image or the scene segments. The object detection model is trained using a reasonable number of samples. The samples include common objects from at least 80 categories.

The object detection (606) model identifies samples or objects within the image or within the scene segments. The detected face and objects are projected to a new feature map with the same size. The detections are converted into rectangular patches filled with the confidence value. The object detection (606) forms an object map, representing details about the object within the image or the scene segment.

By combining the outputs of the saliency map (602), the face detection (604), and the object detection (606), a score map (608) with respect to the image or the scene segment is generated.

Further, in an alternative embodiment, an edge detector or traditional Sobel operator is applied to extract the edge information from the image.

Mathematically, the superimposed score map (608) is the weighted sum of the three components based on the following equation:

ScoreMap_{x,y}=w_{face}*faceMap_{x,y}+w_{obj}*objMaps_{x,y}+w_{edge}*edgeMap_{x,y}

w_{face}=w_{face_pre}*number of occurrences/scene length

w_{obj}=w_{obj_pre}*number of occurrences/scene length

w_{edge}=w_{edge_pre}

In an exemplary embodiment, the weight of face map (604) and object map (606) are determined by a predefined weight based on the occurrence within the scene segment or the image. The weight is proportional to the frequency of the face or object within the interval. Consequently, the weight of each face or object varies according to the number of occurrences. For example, the number of occurrences divided by the scene length at frame K for Object 1, Object 2, and Face 1 are 5/9, 7/9 and 6/9, where 9 is the number of frames in the scene.

The predefined weights of the three components are determined by the importance of the subjects or humans. In a general video or photo taking scenario, the priority of the three faces, objects, and edges follows wface>wobj>wedge so that the human face plays a more significant role in the score map or feature map followed by the object and the edge of the image. In one aspect of the present invention, the score map is also considered as a feature map.

An example is given in Table 1. The example represents occurrence of three instances within the stacked feature frame.

TABLE 1
Example of occurrence of three instances
within the scene. Scene Length = 9

| Frame No | Object 1 | Object 2 | Face 1 |
|---|---|---|---|
| k − 4 | N | Y | N |
| k − 3 | N | Y | Y |
| k − 2 | Y | Y | N |
| k − 1 | Y | Y | N |
| k | N | Y | Y |
| k + 1 | Y | Y | Y |
| k + 2 | Y | Y | Y |
| k + 3 | Y | N | Y |
| k + 4 | N | N | Y |

As illustrated, there are two detected faces in the face detection (604) with different confidence values. The smaller bounding box is filled with a lower confidence value and the brighter box on the right is filled with higher confidence value. The same conversion is applied to the object detection (606) result. Three detected objects are filled with its corresponding confidence value. Further, a score map (608) or the feature map (608) is generated on the basis of the face detection (604), the object detection (606), and the edge detector.

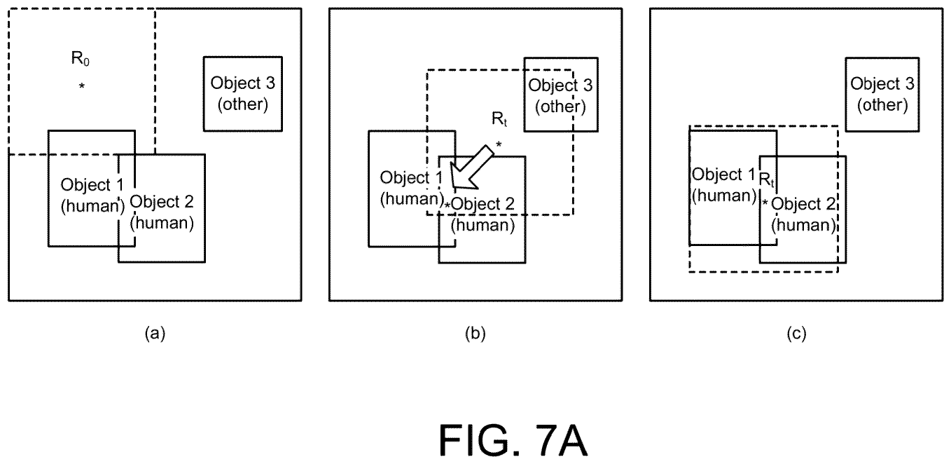

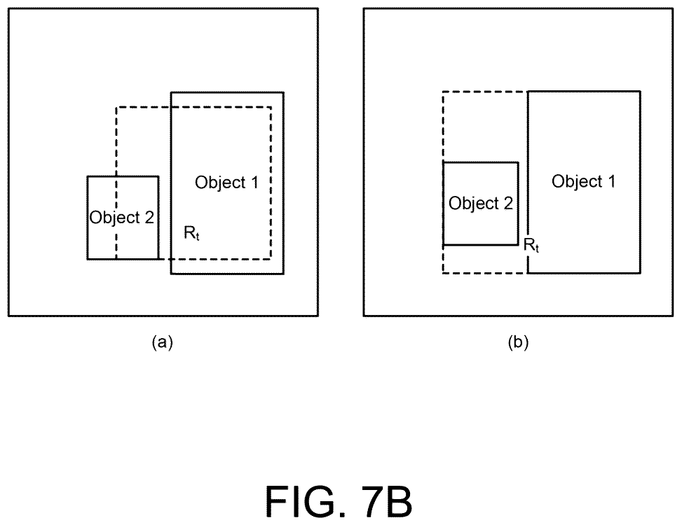

FIG. 7(A) illustrates a region localizer of a cropping module in accordance with the present invention. On the basis of the feature map (608), a region localizer of the cropping module used for localization of the cropping region relies on the scanning of the feature maps. The region localizer is used for scanning the feature maps, and further identifies a number of test areas. After assembling all the feature components into one score map or feature map, a number of feature maps (702, 704, 706) represent faces or objects within the image or the scene segments. A feature map (702) represents an Object 1 detected including a face of the human. Further, another feature map (704) represents Object 2 detected including a face of the human. Further, another feature map (706) represents Object 3 detected including an object within the image or the at least one frame of the scene segment.

Further, a number of hot areas or a number of test areas gathering the maximum information is located or identifies within the image or the frame of the scene segment. In this procedure, a rectangle R is formed with half size of the original image or the frame of the scene segment. The rectangle R represents one or more test areas showing maximum coverage with respect to the image. The score of the rectangle R is defined as the ratio of the inner density to the outer density. In one exemplary embodiment, in the region or the test areas (708), R starts from the top-left corner and iterates over the frame row by row. The region R or the test areas (708) represented by R₀ includes a centroid (712). The rectangle R is taken as a sliding window to walk through the whole image and find out the most desirable area or the one or more test areas covering maximum information.

The area with the highest score is considered as the hot zone of the image. The scores are compared at different time t and the best location with the highest score is identified.

The test areas or region (Rt) is formed at different times. The blue star denotes the centroid (714) of the important overlapped detections such as Object 1 (702) and Object 2 (714). Further, the region R or test areas (708) then move to the place with its centroid (712) overlapped with the centroid (714) of the Object 1 (702) and Object 2 (714). The focal point of the frame of the stacked feature frame or the image is now discovered.

FIG. 7(B) illustrates a deformer of a cropping module in accordance with the present invention. The deformer is used for resizing at least one test area from the one or more test areas. In an exemplary embodiment, the region R or test areas (708) then move to the place with its centroid (712) overlapped with the centroid (714) of the Object 1 (702) and Object 2 (714) covering maximum information. Further, the rectangle R or the test areas (708) is deformed to cover the instances by expanding or shrinking toward the minimal and maximal border of the selected detections in both horizontal and vertical directions. As a result, the selected instances are properly preserved in the final cropping region R. Further, the cropper is used for cropping the region R, and forming the image of interest.

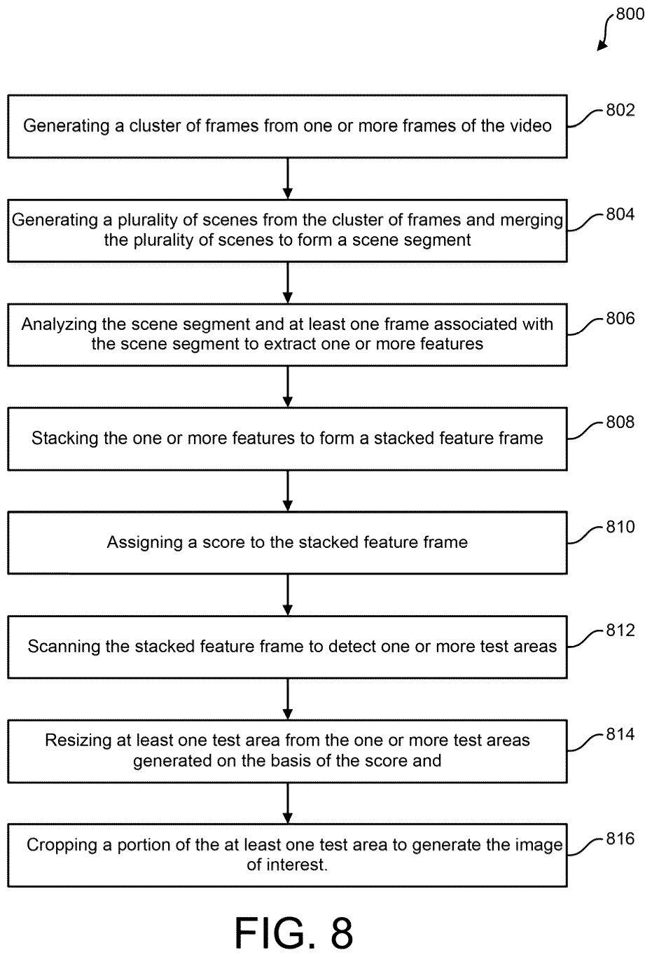

FIG. 8 illustrates a method (800) for smart cropping an image of interest from a video. The method includes a step (802) of generating a cluster of frames from a number of frames of the video. The clusters of frames are generated by using a cluster generator. Further, the method (800) includes a step (804) of generating multiple scenes from the cluster of frames and further merging them to form a scene segment. The scene segment is formed by a scene generator. The method (800) includes a step of (806) of analyzing the scene segment and at least one frame associated with the scene segment to extract one or more features by using a feature extractor.

Further, the method (800) includes a step of (808) of stacking one or more features to form a stacked feature frame. The method (800) includes a step (810) of assigning a score to the stacked feature frame by a scoring module. The method (800) includes a step (812) of scanning the stacked feature frame to detect one or more test areas by a region localizer of a cropping module. The method (800) includes a step (814) of resizing at least one test area from the one or more test areas generated on the basis of the score by a deformer of the cropping module. The method (800) includes a step (816) of cropping a portion of at least one test area to generate the image of interest.

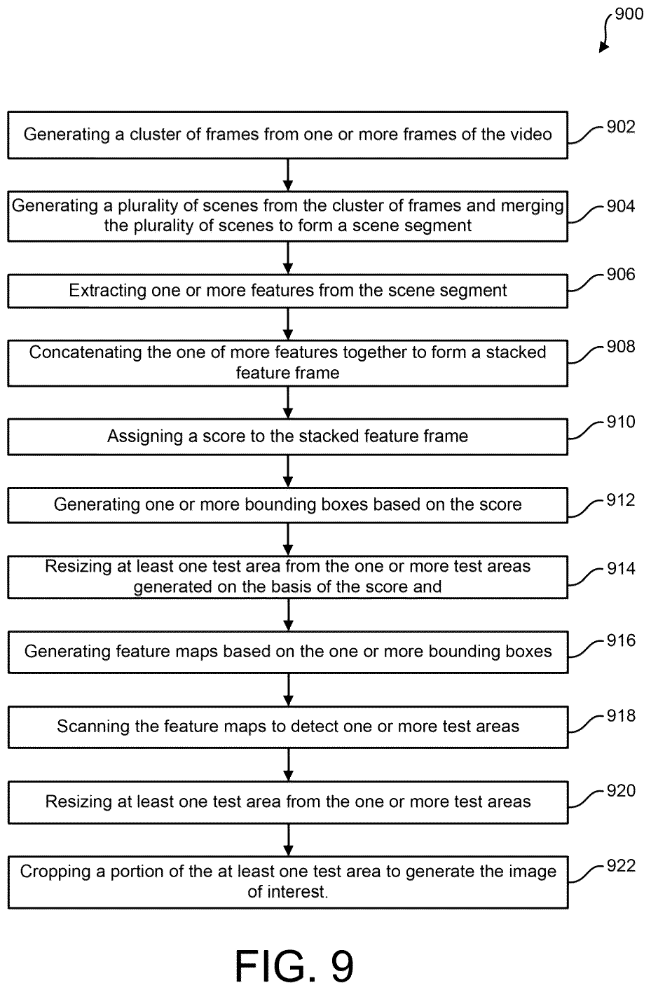

FIG. 9 illustrates a method (900) for the automated cropping of an image of interest from a video sample. The method (900) includes a step (902) of generating a cluster of frames from a number of frames of the video. The clusters of frames are generated by using a cluster generator. The method (900) includes a step (904) of generating a multiple scenes from the cluster of frames and further merging them to form a scene segment. The scene segment is formed by a scene generator. The method (900) includes a step of (906) of analyzing the scene segment and at least one frame associated with the scene segment to extract one or more features by using a feature extractor.

Further, the method (900) includes a step of (908) of concatenating one of more features together to form a stacked feature frame. The method (900) includes a step (910) of assigning a score to the stacked feature frame by a scoring module. The method (900) includes a step (912) of generating one or more bounding boxes based on the score on the stacked scene frame. The method (900) includes a step (914) of generating feature maps based on one or more bounding boxes. The method (900) includes a step (916) of scanning the feature maps to detect one or more test areas. The method (900) includes a step (918) of resizing at least one test area from the one or more test areas within the stacked feature frame. The method (900) includes a step (920) of selecting at least one test area on the basis of the one or more bounding boxes. Further, the method (900) includes a step (922) of cropping a portion of at least one test area to generate the image of interest.

While, the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architecture and configurations.

Although, the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A video cropping system, comprising:
a segmentation module configured to segment a video into a plurality of frames, comprising:
a cluster generator configured to generate a cluster of frames from the plurality of frames; and
a scene generator configured to generate a plurality of scenes from the cluster of frames and to merge the plurality of scenes to form a scene segment;
a feature processing module configured to analyze the scene segment and an associated frame to extract at least one feature, wherein the feature is stacked on the associated frame to form a stacked feature frame;
a scoring module configured to assign a score to the stacked feature frame; and
a cropping module, comprising:
a region localizer configured to scan the stacked feature frame to detect a test area based on the score;
a deformer configured to resize the test area; and
a cropper configured to crop the test area to generate an image of interest.

2. The video cropping system of claim 1, wherein the feature processing module comprises a feature extractor configured to extract the feature.

3. The video cropping system of claim 2, wherein the feature extractor comprises at least one of a facial recognizer configured to recognize a face and an object detector configured to recognize an object.

4. The video cropping system of claim 3, wherein the feature extractor further comprises an edge detector configured to extract edge information from at least one of the face and the object.

5. The video cropping system of claim 1, wherein a feature concatenation unit is configured to stack the feature on the frame to form the stacked feature frame.

6. The video cropping system of claim 1, wherein the cluster generator is further configured to generate the cluster of frames based on a similarity value of the plurality of frames.

7. The video cropping system of claim 6, wherein the cluster of frames is generated using at least one of a K means-algorithm, a UV histograms, and color-space characteristics.

8. The video cropping system of claim 1, wherein the scoring module is further configured to assign the score to the stacked feature frame based on at least one of: the frequency of the feature, edges detected of the feature, lengths of the plurality of scenes, or a confidence value of the feature.

9. The video cropping system of claim 8, wherein the confidence value is based on an artificial intelligence based training model.

10. The video cropping system of claim 9, wherein the confidence value is based on a similarity value of the feature to sample images gathered from the internet.

11. The video cropping system of claim 1, wherein the scoring module is further configured to generate a bounding box on the basis of the score and the bounding box is configured to generate a feature map.

13. The video cropping system of claim 11, wherein a region localizer is further configured to scan the feature map to detect the test area.

14. The video cropping system of claim 11, wherein the bounding box is enclosed within the test area.

15. An automated video cropping system, comprising:
a video segmentation module configured to segment a video sample into a plurality of frames, comprising:
a cluster generator configured to generate a cluster of frames from the plurality of frames; and
a scene generator configured to generate a plurality of scenes from the cluster of frames and to merge the plurality of scenes to form a scene segment;
a feature processing module, comprising:
a feature extractor configured to extract at least one feature from the scene segment; and
a feature concatenator configured to concatenate the feature with an associated frame to form a stacked feature frame;
a feature mapping module, comprising:
a scoring unit configured to assign a score to the stacked feature frame;
a bounding box generator configured to generate a bounding box based on the score; and
a feature map unit configured to generate a feature map based on the bounding box; and
a cropping module, comprising:
a region localizer configured to scan the feature map to detect a test area based on the bounding box;
a deformer configured to resize the test area; and
a cropper configured to crop the test area to generate an image of interest.

16. An image production method, comprising the steps of:
generating a cluster of frames from a plurality of frames of a video;
generating a plurality of scenes from the cluster of frames;
merging the plurality of scenes to form a scene segment;
analyzing the scene segment and a frame associated with the scene segment to extract at least one feature;
stacking the feature with the associated frame to form a stacked feature frame;
assigning a score to the stacked feature frame;
scanning the stacked feature frame to detect a test area;
resizing the test area on the basis of the score; and
cropping the test area to generate an image of interest.

17. An automated image cropping method, comprising the steps of:
generating a cluster of frames from a plurality of frames of a video sample;
generating a plurality of scenes from the cluster of frames;
merging the plurality of scenes to form a scene segment;
extracting at least one feature from the scene segment;
concatenating the feature with an associated frame to form a stacked feature frame;
assigning a score to the stacked feature frame;
generating at least one bounding box based on the score;
generating at least one feature map based on the bounding box;
scanning the feature map to detect at least one test area;
resizing the test area;
selecting the test area based on the bounding box; and
cropping the test area to generate an image of interest.
